(19) United States
(12) Patent Application Publication
(10) Pub. No.: US 2012/0261490 A1
(43) Pub. Date: Oct. 18, 2012

(54) COLOR SPECIFIC CORRECTION FLUID

(76) Inventor: Rebecca Barker, Elkhorn, WV (US)

(21) Appl. No.: 13/086,948

(22) Filed: Apr. 14, 2011

(51) Int. Cl. B05B 9/00; C09D 10/00; A46B 11/00

(52) U.S. Cl. 239/302; 401/268; 106/31.93

(57) ABSTRACT

The present invention is colored correction fluid to correct mistakes on colored paper with the colored correction fluid contained in a spray bottle and dispersed and sprayed from the bottle onto the mistakes. The colored correction fluid can be applied with a brush applicator and includes a casing and a thumb hold disposed on the casing to allow a user to better hold, grasp and direct the applicator. The colored correction fluid is contained in the casing and applied onto the mistakes using a brush. Colored correction fluid can also be removably disposed on colored correction sheet material to correct mistakes on colored paper, with colored correction material directly applied onto the mistakes. The colored correction fluid can be matched to the dye on the colored paper and is available in a variety of popular colors.

### TECHNICAL FIELD & BACKGROUND

The present invention generally relates to correction fluid and correction materials. More specifically, the invention is a color specific correction fluid that can be dispersed with a spray bottle, brush applicator or correction materials.

It is an object of the invention to provide a color specific correction fluid and correction materials that can be used to correct printing errors on a variety of colored paper stock.

It is an object of the invention to provide a color specific correction fluid that can be dispersed with a spray bottle or applied with a brush applicator to correct printing errors on a variety of colored paper stock.

What is really needed is a color specific correction fluid and correction material that can be used to correct printing errors on a variety of colored paper stock and that can be dispersed with a spray bottle or applied with a brush applicator to correct printing errors on a variety of colored paper stock.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side perspective view of a spray bottle of colored correction fluid, in accordance with one embodiment of the present invention.

FIG. 2 illustrates a side perspective view of a brush applicator, in accordance with one embodiment of the present invention.

FIG. 3 illustrates a side perspective view of colored correction material, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

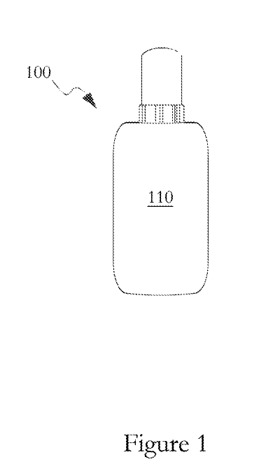

FIG. 1 illustrates a side perspective view of a spray bottle of colored correction fluid 100, in accordance with one embodiment of the present invention. The spray bottle of colored correction fluid 100 contains and disperses colored correction fluid 110 used to correct printed mistakes on colored paper. The colored correction fluid 110 comes in a variety of colors that match the color of popular colored papers that include pink, beige, violet, blue, yellow, green, off-white, neon and other suitable colors. The colored correction fluid 110 is an improvement over using white correction fluid, that would appear messy and conspicuous if used to correct a printed mistake on any other color of paper other than white paper. The colored correction fluid 110 simply matches the color of the paper that the printed mistake is printed on and is sprayed over the printed mistake to inconspicuously cover the printed mistake.

Currently within the market there have been minimal enhancements to correctional fluids. Liquid amendment supplies, such as White Out™, are only efficient when applied to standard white printing paper, thus limiting options to utilize the substance on alternative colored paper materials. The color specific colored correction fluid 110 is an assorted color correction fluid that serves as a complimentary base for editing printing mistakes. Improving upon the traditional White Out™ formula, the color specific correction fluid 110 utilizes a solvent that allows the color specific correction fluid 110 to match the specific dye used on various paper materials. Varying colors of correction fluid enables users to apply a foundational cover to mask an error while allowing for supplemental modifications to appear discreet and in harmony with the original text.

The color specific correction fluid 110 can be marketed for commercial, educational and individual consumer use. The colored correction fluid 110 offers a manual editing solution effective on diverse colored printing materials. The feature of the colored correction fluid 110 that complements paper stock in neon, contrast or traditional colors, alleviates the concern of amending minor printing inaccuracies.

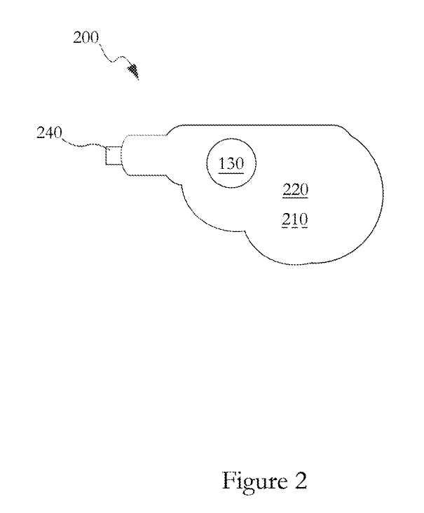

FIG. 2 illustrates a side perspective view of a brush applicator 200, in accordance with one embodiment of the present invention. The brush applicator 200 utilizes the same colored correction fluid 210 described in FIG. 1 with the same features and characteristics. The colored correction fluid 210 comes in a variety of colors that match the color of popular colored papers that include pink, beige, violet, blue, yellow, green, off-white and other suitable colors. The colored correction fluid 210 is an improvement over using white correction fluid, that would appear messy and conspicuous if used to correct a printed mistake on any other color of paper other than white paper. The colored correction fluid 210 is matched to the color of the paper that the printed mistake is printed on and is applied over the printed mistake to inconspicuously cover the printed mistake.

The brush applicator 200 has an ergonomically designed casing 220 to accommodate a variety of different sized users' hands. The brush applicator 200 includes a thumb hold 230 that is disposed on the sides of the brush applicator 200 to allow a user to better hold or grasp and direct the brush applicator 200. The thumb hold 230 is made of slip resistant material, which can be any suitable slip resistant material. The colored correction fluid 210 is contained in the brush applicator 200 and is applied directly to a printed mistake through a brush 240. The brush 240 is typically made of absorbent material to hold the applied colored correction fluid 210 for relatively easier application of the colored correction fluid 210 while being applied.

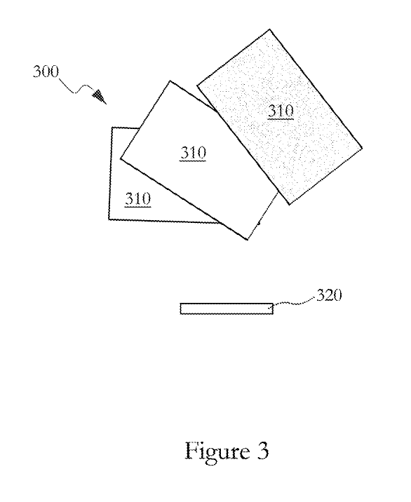

FIG. 3 illustrates a side perspective view of a colored correction material 300, in accordance with one embodiment of the present invention. The colored correction material 300 is utilized the same way that white colored correction materials are utilized in that the colored correction fluid 310 removably disposed on the surface of the colored correction material 300 is directly applied to the printed error. The colored correction material 300 can be in strip form 320 or can be cut into a desired shape from a sheet of colored correction material 300.

As previously indicated in the FIG. 1 and FIG. 2 descriptions, the colored correction fluid 310 comes in a variety of colors that match the color of popular colored papers that include pink, beige, violet, blue, yellow, green, off-white and other suitable colors. The colored correction fluid 310 is an improvement over using white correction fluid, that would appear messy and conspicuous if used to correct a printed mistake on any other color of paper other than white paper. The colored correction fluid 310 is simply matched with the color of the paper that the printed mistake is printed on and is physically applied over the printed mistake to inconspicuously cover the printed mistake.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A spray bottle of colored correction fluid to correct mistakes on colored paper, comprising:
colored correction fluid contained in said bottle and dispersed and sprayed from said bottle onto said mistakes.

2. The bottle according to claim 1, wherein said colored correction fluid matches dye on said colored paper.

3. The bottle according to claim 1, wherein said colored correction fluid is sprayed over said mistake to inconspicuously cover said mistake.

4. The bottle according to claim 3, wherein said colored correction fluid colors include pink, beige, violet, blue, yellow, green, off-white and neon.

5. The bottle according to claim 1, wherein said mistakes are printed mistakes.

6. A brush applicator to correct mistakes on colored paper, comprising:
a casing with a side and an end;
a thumb hold disposed on said side of casing to allow a user to better hold, grasp and direct said applicator;
colored correction fluid contained in said casing: and
a brush to apply said correction fluid onto said mistakes disposed on said end of casing.

7. The applicator according to claim 6, wherein said casing is ergonomically designed.

8. The applicator according to claim 6, wherein said thumb hold is made of slip resistant material.

9. The applicator according to claim 6, wherein said colored correction fluid matches dye on said colored paper.

10. The applicator according to claim 6, wherein said colored correction fluid is applied over said mistake to inconspicuously cover said mistake.

11. The applicator according to claim 10, wherein said colored correction fluid colors include pink, beige, violet, blue, yellow, green, off-white and neon.

12. The applicator according to claim 6, wherein said brush is made of absorbent material.

13. The bottle according to claim 6, wherein said mistakes are printed mistakes.

14. A colored correction material to correct mistakes on colored paper, comprising:
a sheet made of said colored correction material;
and colored correction fluid removably disposed on said sheet and directly applied onto said mistakes.

15. The material according to claim 14, wherein said sheet can be cut into any desired shape.

16. The material according to claim 14, wherein said material is a strip.

17. The material according to claim 14, wherein said colored correction fluid matches dye on said colored paper.

18. The material according to claim 14, wherein said colored correction fluid is applied over said mistake to inconspicuously cover said mistake.

19. The material according to claim 18, wherein said colored correction fluid colors include pink, beige, violet, blue, yellow, green, off-white and neon.

20. The material according to claim 14, wherein said mistakes are printed mistakes.
